(19) United States
(12) Patent Application Publication
(10) Pub. No.: US 2024/0340954 A1
(43) Pub. Date: Oct. 10, 2024

(54) CHANNEL OCCUPANCY TIME (COT) SHARING

(71) Applicant: QUALCOMM Incorporated, San Diego, CA (US)

(72) Inventors: Luanxia YANG, Beijing (CN); Jing SUN, San Diego, CA (US); Changlong XU, Beijing (CN); Shaozhen GUO, Beijing (CN); Xiaoxia ZHANG, San Diego, CA (US); Aleksandar DAMNJANOVIC, Del Mar, CA (US)

(21) Appl. No.: 18/580,573

(22) PCT Filed: Sep. 24, 2021
(86) PCT No.: PCT/CN2021/120156

§ 371 Date: Jan. 18, 2024

(51) Int. Cl. H04W 74/0816; H04W 72/044; H04W 74/08

(52) U.S. Cl. CPC H04W 74/0816; H04W 72/044; H04W 74/0866

(57) ABSTRACT

A method of wireless communication by an initiating device, includes acquiring a channel occupancy time (COT) including multiple subsets of COT sharing resources. Each of the subsets includes fewer resources than the entire COT. The method also includes configuring a first responding device with a first of the subsets of COT sharing resources. The method further includes configuring a second responding device with a second of the subsets of COT sharing resources. A method of wireless communication by a responding device receives, from an initiating device, a first subset of multiple subsets of channel occupancy time (COT) sharing resources. The first subset differs from a second subset of COT sharing resources configured for another device. The method also includes selecting transmission resources from the first subset of COT sharing resources in response to detecting the initiating device acquired the COT, and then transmitting data on the selected transmission resources.

### FIELD OF THE DISCLOSURE

The present disclosure relates generally to wireless communications, and more specifically to restricted channel occupancy time (COT) sharing.

### BACKGROUND

Wireless communications systems are widely deployed to provide various telecommunications services such as telephony, video, data, messaging, and broadcasts. Typical wireless communications systems may employ multiple-access technologies capable of supporting communications with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and long term evolution (LTE). LTE/LTE-Advanced is a set of enhancements to the universal mobile telecommunications system (UMTS) mobile standard promulgated by the Third Generation Partnership Project (3GPP). Narrowband (NB)-Internet of things (IoT) and enhanced machine-type communications (eMTC) are a set of enhancements to LTE for machine type communications.

A wireless communications network may include a number of base stations (BSs) that can support communications for a number of user equipment (UEs). A user equipment (UE) may communicate with a base station (BS) via the downlink and uplink. The downlink (or forward link) refers to the communications link from the BS to the UE, and the uplink (or reverse link) refers to the communications link from the UE to the BS. As will be described in more detail, a BS may be referred to as a Node B, an evolved Node B (eNB), a gNB, an access point (AP), a radio head, a transmit and receive point (TRP), a new radio (NR) BS, a 5G Node B, and/or the like.

The above multiple access technologies have been adopted in various telecommunications standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation.

### SUMMARY

In aspects of the present disclosure, a method of wireless communication by an initiating device includes acquiring a channel occupancy time (COT) including multiple subsets of COT sharing resources. Each subset of COT sharing resources includes fewer resources than the COT. The method also includes configuring a first responding device with a first of the subsets of COT sharing resources. The method further includes configuring a second responding device with a second of the subsets of COT sharing resources.

In other aspects of the present disclosure, a method of wireless communication by a responding device includes receiving, from an initiating device, a first subset of channel occupancy time (COT) sharing resources of multiple subsets of COT sharing resources of a COT. The first subset of COT sharing resources differs from a second subset of COT sharing resources configured for another device. The method also includes selecting transmission resources from the first subset of COT sharing resources in response to detecting the initiating device acquired the COT. The method further includes transmitting data on the selected transmission resources.

Other aspects of the present disclosure are directed to an apparatus for wireless communication by an initiating device having a memory and one or more processors coupled to the memory. The processor(s) is configured to acquire a channel occupancy time (COT) including multiple subsets of COT sharing resources. Each subset of COT sharing resources includes fewer resources than the COT. The processor(s) is also configured to configure a first responding device with a first of the subsets of COT sharing resources. The processor(s) is further configured to configure a second responding device with a of the subsets of COT sharing resources.

Aspects generally include a method, apparatus, system, computer program product, non-transitory computer-readable medium, user equipment, base station, wireless communications device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communications network, in accordance with various aspects of the present disclosure.

FIG. 2 is a block diagram conceptually illustrating an example of a base station in communication with a user equipment (UE) in a wireless communications network, in accordance with various aspects of the present disclosure.

FIG. 3 is a block diagram illustrating channel occupancy time (COT) sharing with a configured grant uplink control information (CG-UCI) message.

FIG. 4 is a block diagram illustrating pre-configured restricted resource allocation for COT sharing, in accordance with aspects of the present disclosure.

FIG. 5 is a block diagram illustrating percentage-based pre-configured restricted resource allocation for COT sharing, in accordance with aspects of the present disclosure.

FIG. 6A is a block diagram illustrating dynamic dedicated resource allocation for COT sharing for transmissions, in accordance with aspects of the present disclosure.

FIG. 6B is a block diagram illustrating dynamic dedicated resource allocation for COT sharing for transmission bursts, in accordance with aspects of the present disclosure.

FIG. 7A is a block diagram illustrating dynamic indication of available COT sharing resources for transmissions, in accordance with aspects of the present disclosure.

FIG. 7B is a block diagram illustrating dynamic indication of available COT sharing resources for transmission bursts, in accordance with aspects of the present disclosure.

FIG. 8 is a flow diagram illustrating an example process performed, for example, by an initiating device, in accordance with various aspects of the present disclosure.

FIG. 9 is a flow diagram illustrating an example process performed, for example, by a responding device, in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with 5G and later wireless technologies, aspects of the present disclosure can be applied in other generation-based communications systems, such as and including 3G and/or 4G technologies.

Communications in unlicensed frequency bands differ from communications in licensed frequency bands. For unlicensed spectrums, channel access is an issue. For channel access, an initiating device determines whether a channel is available. If available, the channel can be used for a period of time, referred to as a channel occupancy time (COT). The initiating device may decide to share access to the COT so that other devices, referred to as responding devices, may also communicate during the COT. Currently, the responding devices select their own resources during a COT, which may lead to collisions of transmissions from different devices. The initiating device may be a user equipment (UE) or a base station. In the case of a UE as the initiating device, the responding device may be a base station or another UE for sidelink scenarios.

According to aspects of the present disclosure, restricted COT sharing is introduced. With restricted COT sharing, each responding device is configured with only a portion of the COT. As a result, collisions may be avoided.

According to aspects of the present disclosure, pre-configured COT sharing and dynamically indicated COT sharing are examples of two different types of COT sharing. For pre-configured COT sharing, if a device successfully initiates a COT, each responding device will be pre-configured with a set of fixed resources to share. When a responding device detects the initiating device acquired the channel, the responding device selects from the pre-configured resources to transmit. If different responding devices are configured with orthogonal fixed resources, their COT sharing will not collide. In some aspects, a resource may be configured with an absolution location. In other aspects, a resource may be configured with respect to a triggering signal transmission location. For example, the triggering signal may contain information indicating a location for the restricted sharable resource, selected from multiple pre-configured resources.

One technique for dynamic indication includes pre-configuring multiple locations and dynamically indicating the chosen location. With this technique, the initiating UE or base station pre-configures a set of fixed resources for each responding device. Frequency division resource allocation or time division resource allocation may be expressed as the percentage of COT duration or absolute value. The COT sharing information may also dynamically indicate which UE can share which dedicated resource.

Another technique for dynamic indication of COT sharing resources includes dynamically indicating dedicated resources for each UE. If the COT is shared with a single user, the frequency division resource allocation and time division resource allocation of the shared resource may be configured with an offset, duration, and frequency range, as described with respect to the pre-configured resources. This absolute or percentage-based configuration may occur if the responding device knows the fixed frame period (FFP) configuration of the initiating device. Alternatively, the absolute starting time, duration, starting frequency, and range of resources may be indicated.

If the COT is shared with multiple users, a UE identifier may be included. In this case, the initiating device may indicate a starting sharing time, which may either be an absolute starting time, or a percentage based on the COT duration. In this case, the shared resources should end before the next starting sharing time. In other aspects, the initiating device may also only indicate a starting point of frequency. All the information may be aggregated into one COT sharing indication (COT-SI) message.

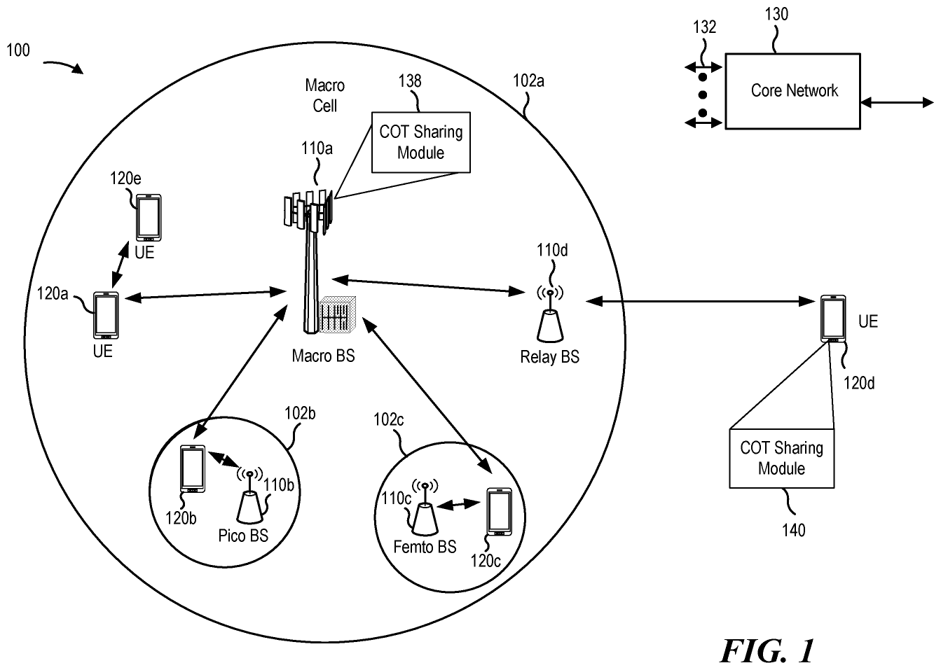

FIG. 1 is a diagram illustrating a network 100 in which aspects of the present disclosure may be practiced. The network 100 may be a 5G or NR network or some other wireless network, such as an LTE network. The wireless network 100 may include a number of BSs 110 (shown as BS 110a, BS 110b, BS 110c, and BS 110d) and other network entities. A BS is an entity that communicates with user equipment (UEs) and may also be referred to as a base station, an NR BS, a Node B, a gNB, a 5G node B, an access point, a transmit and receive point (TRP), and/or the like. Each BS may provide communications coverage for a particular geographic area. In 3GPP, the term “cell” can refer to a coverage area of a BS and/or a BS subsystem serving this coverage area, depending on the context in which the term is used.

A BS may provide communications coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB,” “base station,” “NR BS,” “gNB,” “AP,” “node B,” “5G NB,” “TRP,” and “cell” may be used interchangeably.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

The wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communications between the BS 110a and UE 120d. A relay station may also be referred to as a relay BS, a relay base station, a relay, and/or the like.

The wireless network 100 may be a heterogeneous network that includes BSs of different types, e.g., macro BSs, pico BSs, femto BSs, relay BSs, and/or the like. These different types of BSs may have different transmit power levels, different coverage areas, and different impact on interference in the wireless network 100. For example, macro BSs may have a high transmit power level (e.g., 5 to 40 Watts) whereas pico BSs, femto BSs, and relay BSs may have lower transmit power levels (e.g., 0.1 to 2 Watts).

As an example, the BSs 110 (shown as BS 110a, BS 110b, BS 110c, and BS 110d) and the core network 130 may exchange communications via backhaul links 132 (e.g., S1, etc.). Base stations 110 may communicate with one another over other backhaul links (e.g., X2, etc.) either directly or indirectly (e.g., through core network 130).

The core network 130 may be an evolved packet core (EPC), which may include at least one mobility management entity (MME), at least one serving gateway (S-GW), and at least one packet data network (PDN) gateway (P-GW). The MME may be the control node that processes the signaling between the UEs 120 and the EPC. All user IP packets may be transferred through the S-GW, which itself may be connected to the P-GW. The P-GW may provide IP address allocation as well as other functions. The P-GW may be connected to the network operator's IP services. The operator's IP services may include the Internet, the Intranet, an IP multimedia subsystem (IMS), and a packet-switched (PS) streaming service.

The core network 130 may provide user authentication, access authorization, tracking, IP connectivity, and other access, routing, or mobility functions. One or more of the base stations 110 or access node controllers (ANCs) may interface with the core network 130 through backhaul links 132 (e.g., S1, S2, etc.) and may perform radio configuration and scheduling for communications with the UEs 120. In some configurations, various functions of each access network entity or base station 110 may be distributed across various network devices (e.g., radio heads and access network controllers) or consolidated into a single network device (e.g., a base station 110).

UEs 120 (e.g., 120a, 120b, 120c) may be dispersed throughout the wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communications device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

One or more UEs 120 may establish a protocol data unit (PDU) session for a network slice. In some cases, the UE 120 may select a network slice based on an application or subscription service. By having different network slices serving different applications or subscriptions, the UE 120 may improve its resource utilization in the wireless communications system 100, while also satisfying performance specifications of individual applications of the UE 120. In some cases, the network slices used by UE 120 may be served by an AMF (not shown in FIG. 1) associated with one or both of the base station 110 or core network 130. In addition, session management of the network slices may be performed by an access and mobility management function (AMF).

The UEs 120 may include a COT sharing module 140. For brevity, only one UE 120d is shown as including the COT sharing module 140. The COT sharing module 140 may acquire a channel occupancy time (COT) including multiple subsets of COT sharing resources. Each subset of COT sharing resources includes fewer resources than the COT. The COT sharing module 140 may also configure a first responding device with a first of the subsets of COT sharing resources. The COT sharing module 140 may also configure a second responding device with a second of the subsets of COT sharing resources.

The base stations 110 may include a COT sharing module 138 for brevity, only one base station 110a is shown as including the COT sharing module 138. The COT sharing module 138 may receive, from an initiating device, a first subset of channel occupancy time (COT) sharing resources of multiple subsets of COT sharing resources of a COT. The first subset of COT sharing resources differs from a second subset of COT sharing resources configured for another device. The COT sharing module 138 may also select transmission resources from the first subset of COT sharing resources in response to detecting the initiating device acquired the COT. The COT sharing module 138 may also transmit data on the selected transmission resources.

Some UEs may be considered machine-type communications (MTC) or evolved or enhanced machine-type communications (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communications link. Some UEs may be considered Internet-of-Things (IoT) devices, and/or may be implemented as NB-IoT (narrowband Internet of things) devices. Some UEs may be considered a customer premises equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere as being performed by the base station 110. For example, the base station 110 may configure a UE 120 via downlink control information (DCI), radio resource control (RRC) signaling, a media access control-control element (MAC-CE) or via system information (e.g., a system information block (SIB).

As indicated above, FIG. 1 is provided merely as an example. Other examples may differ from what is described with regard to FIG. 1.

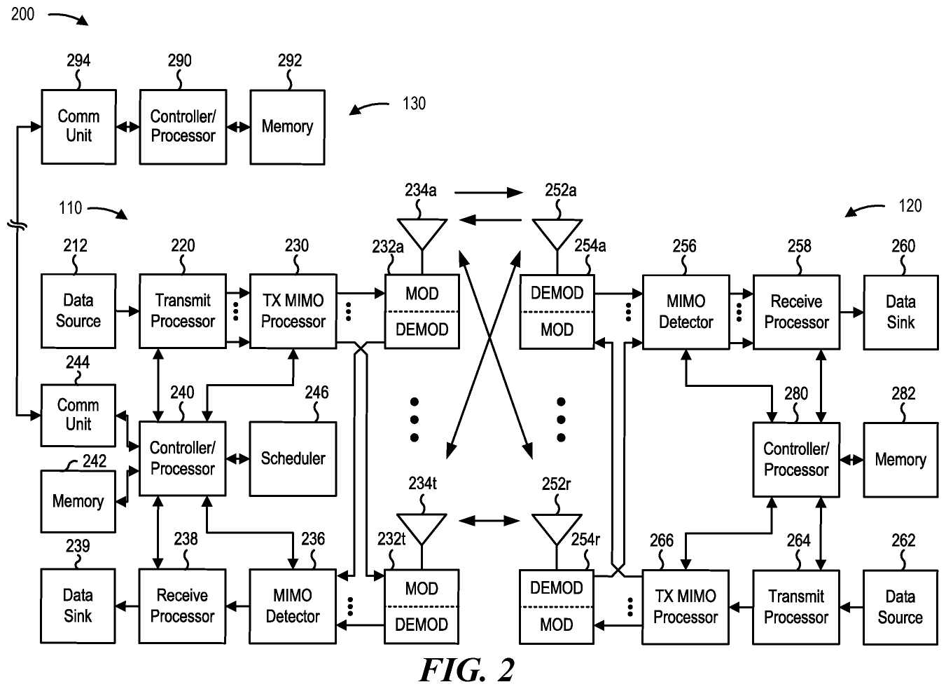

FIG. 2 shows a block diagram of a design 200 of the base station 110 and UE 120, which may be one of the base stations and one of the UEs in FIG. 1. The base station 110 may be equipped with T antennas 234a through 234t, and UE 120 may be equipped with R antennas 252a through 252r, where in general T≥1 and R≥1.

At the base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Decreasing the MCS lowers throughput but increases reliability of the transmission. The transmit processor 220 may also process system information (e.g., for semi-static resource partitioning information (SRPI) and/or the like) and control information (e.g., CQI requests, grants, upper layer signaling, and/or the like) and provide overhead symbols and control symbols. The transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At the UE 120, antennas 252a through 252r may receive the downlink signals from the base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for the UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 120 may be included in a housing.

On the uplink, at the UE 120, a transmit processor 264 may receive and process data from a data source 262 and control information (e.g., for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a TX MIMO processor 266 if applicable, further processed by modulators 254a through 254r (e.g., for DFT-s-OFDM, CP-OFDM, and/or the like), and transmitted to the base station 110. At the base station 110, the uplink signals from the UE 120 and other UEs may be received by the antennas 234, processed by the demodulators 254, detected by a MIMO detector 236 if applicable, and further processed by a receive processor 238 to obtain decoded data and control information sent by the UE 120. The receive processor 238 may provide the decoded data to a data sink 239 and the decoded control information to a controller/processor 240. The base station 110 may include communications unit 244 and communicate to the core network 130 via the communications unit 244. The core network 130 may include a communications unit 294, a controller/processor 290, and a memory 292.

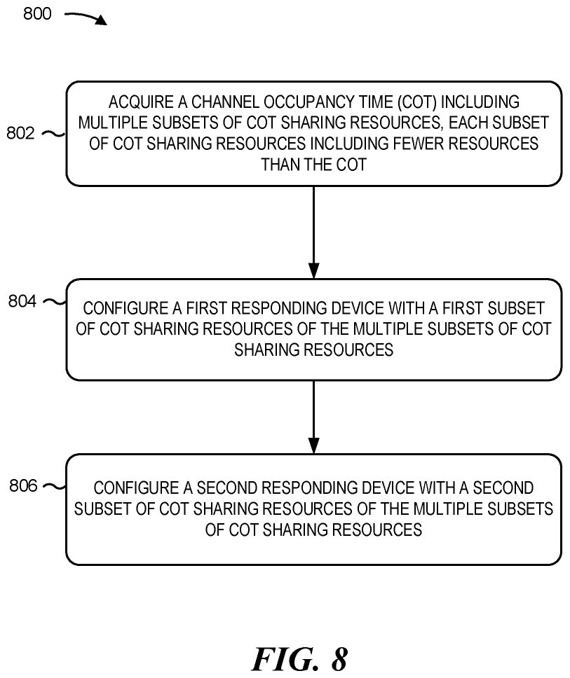

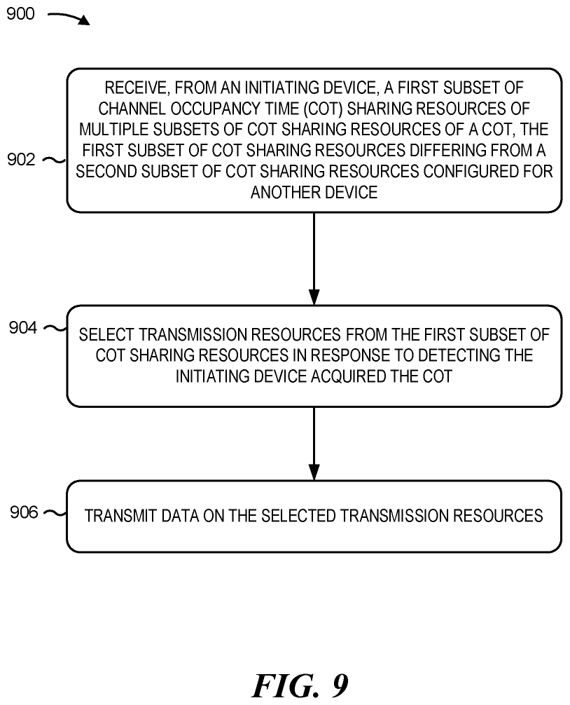

The controller/processor 240 of the base station 110, the controller/processor 280 of the UE 120, and/or any other component(s) of FIG. 2 may perform one or more techniques associated with restricted COT sharing as described in more detail elsewhere. For example, the controller/processor 240 of the base station 110, the controller/processor 280 of the UE 120, and/or any other component(s) of FIG. 2 may perform or direct operations of, for example, the processes of FIGS. 8 and 9 and/or other processes as described. Memories 242 and 282 may store data and program codes for the base station 110 and UE 120, respectively. A scheduler 246 may schedule UEs for data transmission on the downlink and/or uplink.

In some aspects, the UE 120 or base station 110 may include means for acquiring, means for configuring, means for receiving, means for collecting, means for selecting, and/or means for transmitting. Such means may include one or more components of the UE 120 or base station 110 described in connection with FIG. 2.

As indicated above, FIG. 2 is provided merely as an example. Other examples may differ from what is described with regard to FIG. 2.

To support the industrial Internet of things (IIoT) use case in unlicensed frequency bands, a frame-based equipment (FBE) mode is supported in new radio unlicensed bands (NR-U) to improve quality of service (QOS) (for example, for ultra-reliable low-latency communication (URLLC) traffic). A load-based equipment (LBE) mode may support devices with a demand driven transmit/receive structure. For communications in unlicensed frequency bands, the base station or the UE (referred to as an initiating device) may contend for a channel to obtain a channel occupancy time (COT). Once a COT is obtained, the initiating device may choose to share the COT with other devices to balance access for fair sharing between devices. The base station may share a base station initiated COT with a UE. A UE may share a UE initiated COT with a base station. A UE may also share a UE initiated COT with another UE, for example, with sidelink communication.

An initiating UE that shares a COT with a base station may be an example of uplink (UL) to downlink (DL) COT sharing. When uplink to downlink channel COT sharing occurs, an energy detection (ED) threshold may be configured such that the base station can send user plane data to the UE sharing the channel occupancy time if the threshold is met. The base station configures a table for sharing parameters. Each row of the table includes a number of slots (D) where downlink transmissions can be assumed within the UE initiated COT, and a downlink offset (O) indicating a starting slot of downlink transmission. The downlink offset may be indicated as a number of slots from an end of a slot where the indicated number of slots (D) for downlink transmissions can be assumed within the initiated COT, where D is greater than zero. Each row of the table also includes a channel access priority class (CAPC) of the traffic.

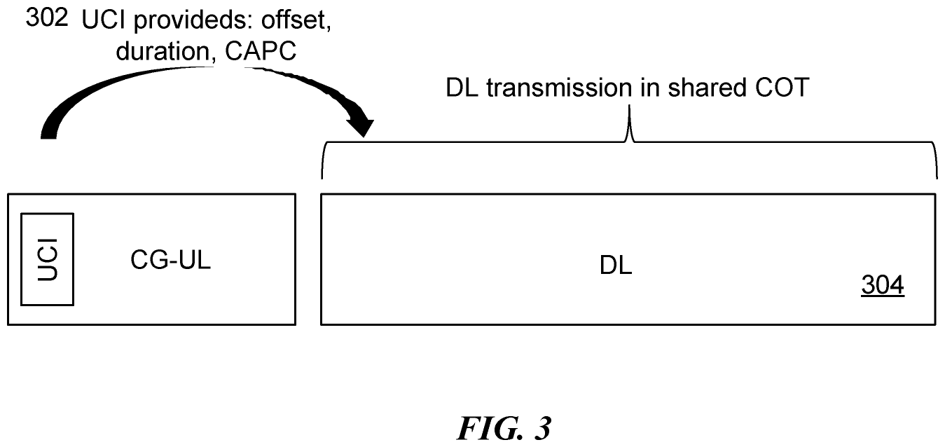

When an uplink to downlink channel occupancy time sharing energy detection (ED) threshold is not configured, the base station (e.g., gNB) cannot send user plane data to the UE sharing the channel occupancy time. In this case, a sharing offset (X) is configured in a configured grant uplink control information (CG-UCI) message. FIG. 3 is a block diagram illustrating channel occupancy time (COT) sharing with a CG-UCI message 302. The CG-UCI message 302 carries a one-bit COT sharing indication of whether slot or symbol n+X is an applicable slot for uplink to downlink sharing, where n is an integer. The sharing offset X is a number of symbols from an end of the slot where the CG-UCI is transmitted, and is configured by the base station as part of radio resource control (RRC) configuration. The CG-UCI message 302 also indicates a duration of the COT and a CAPC of the traffic. In response to receiving the CG-UCI message 302, a downlink transmission 304 occurs in the shared COT.

Currently, RRC configuration enables COT sharing with a base station. An uplink to downlink channel occupancy time sharing energy detection threshold (u1-toDL-COT-SharingED-Threshold) indicates a maximum energy detection threshold that the UE should use to share channel occupancy with the base station for downlink transmission. The length may be no longer than two, four, or eight orthogonal frequency division multiplexing (OFDM) symbols for 15 kHz, 30 kHz, or 60 kHz subcarrier spacing (SCS), respectively, as specified in 3GPP TS 37.213. A configured grant channel occupancy time sharing list (cg-COT-SharingList) indicates a table for channel occupancy time sharing combinations (see 3GPP 37.213, clause 4.1.3). One row of the table can be set to no COT-Sharing to indicate that there is no channel occupancy sharing. A configured grant channel occupancy time sharing offset for Release 16 (cg-COT-SharingOffset-r16) indicates the offset from the end of the slot where the channel occupancy time (COT) sharing indication in UCI is enabled. The offset in symbols is equal to 14*n, where n is the signaled value for cg-COT-SharingOffset. This value is applicable when the u1-toDL-COT-SharingED-Threshold-r16 is not configured.

A UE may share its initiated channel occupancy time (COT) with the base station, and also with other sidelink UEs. COT sharing generally focuses on the time domain. That is, the responding device can share the channel occupancy time with a starting time and length. However, multiple devices may contend for the channel at the same time and frequency location.

In order to further reduce collisions, aspects of the present disclosure introduce restricted COT sharing where not all resources in the remaining COT can be shared and there is additional control on who can share which resources. As a result, an initiating node may be able to acquire the channel and share the COT with multiple other nodes for some arranged transmission to avoid collision between COT sharing nodes. The initiating node may also issue a set of grants for the other nodes to achieve a similar effect, at the cost of numerous grants being transmitted. This grant-based approach, however, does not solve the problem if the initiating node is unaware of whether the other nodes have anything to transmit.

According to aspects of the present disclosure, pre-configured COT sharing and dynamically indicated COT sharing are examples of two types of COT sharing. For pre-configured COT sharing, if a device initiates a COT successfully, each responding device will be pre-configured with a set of fixed resources to share. When a responding device detects the initiating device acquired the channel, the responding device selects from the pre-configured resources to transmit. If different responding devices are configured with orthogonal fixed resources, their COT sharing will not collide. In some aspects, a resource may be configured with an absolution location. In other aspects, a resource may be configured with respect to a triggering signal transmission location. For example, the triggering signal may contain information indicating a location for the restricted sharable resource, selected from multiple pre-configured resources.

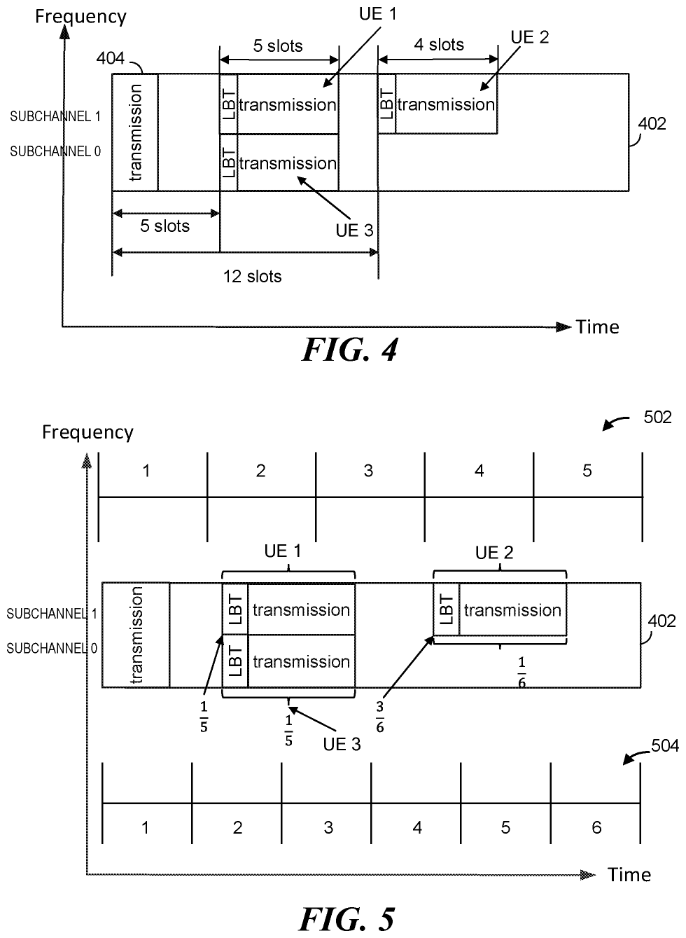

FIG. 4 is a block diagram illustrating pre-configured restricted resource allocation for channel occupancy time (COT) sharing, in accordance with aspects of the present disclosure. In the example of FIG. 4, the content of the pre-configuration includes a time domain resource allocation (TDRA) and a frequency domain resource allocation (FDRA). With respect to time domain resource allocation, the pre-configuration indicates a starting point of the resource when the responding device can share a COT 402. The timing offset indicates a starting slot of the responding device's transmission. The starting slot may be indicated as a number of slots from the starting point of the COT 402. In some aspects, the offset will be expressed as the exact number of slots. In the example of FIG. 4, the offset for UE 1 and UE 3 is five slots. The offset for UE 2 is twelve slots. Thus, UE 1 and UE 3 each perform a listen-before-talk (LBT) procedure five slots after the start of the COT 402. UE 2 performs its LBT procedure twelve slots after the starting point. Each UE transmits after successful completion of the LBT procedure. In the example of FIG. 4, the UE transmissions may be physical uplink shared channel (PUSCH) transmissions. In a sidelink scenario, the transmissions may be physical sidelink control channel (PSCCH) transmissions. The present disclosure contemplates any type of transmission.

The pre-configuration also indicates a frequency. A seen in the example of FIG. 4, UE 1 and UE 2 are both configured with the same subchannel, whereas UE 3 is configured with a different subchannel. The pre-configuration indicates a duration of the resource, in other words, how long the responding device can share the resource. In the example of FIG. 4, the duration is expressed as an exact number of slots. More specifically, the duration for UE 1 and UE 3 is five slots, whereas the duration for the UE 2 resources is four slots. In the example of FIG. 4, the initiating UE performs a first transmission 404 at the beginning of the COT 402, before any of the shared resources. In the example of FIG. 4, the initiating UE transmission may be a PUSCH transmission. In a sidelink scenario, the transmissions may be physical sidelink control channel (PSCCH) transmissions. Although FIG. 4 illustrates an initiating device as a UE, the initiating device can also be a base station.

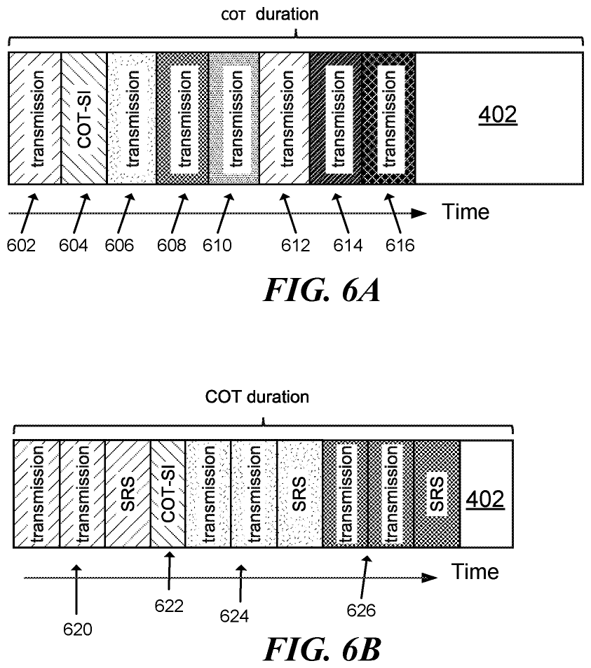

FIG. 5 is a block diagram illustrating percentage-based pre-configured restricted resource allocation for COT sharing, in accordance with aspects of the present disclosure. In aspects of the present disclosure, as illustrated in FIG. 5, the offset is expressed as a percentage of the whole COT 402. For example, in FIG. 5, UE 1 and UE 3 are configured with an offset of ⅕. That is, the shared COT resource begins ⅕ of the time into the COT 402. A grid 502 illustrates the length of the COT 402 divided into five equal parts. Thus, it can be seen that the LBT processes of UE 1 and UE 3 begin ⅕ of the time into the COT 402. The offset configuration for UE 2 is ⅙. A grid 504 illustrates the length of the COT 402 divided into six equal parts. Thus, it can be seen that the LBT process of UE 2 begins ⅙ of the time into the COT 402. According to aspects of the present disclosure, the duration may also be expressed as a percentage of the whole COT duration. In the example of FIG. 5, UE 1 and UE 3 are configured with a duration of ⅕. UE 2 is configured with a duration of ⅙. The grids 502, 504 helps show the durations of the shared resources for UE 1, UE 2, and UE 3. For UEs operating in the LBE mode, the offset and duration expressed as a percentage of the whole COT duration may be suitable, as the starting point and duration each vary over time with LBE operation, making it difficult to configure an exact number of slots.

With respect to frequency domain resource allocation (FDRA), the frequency range where the responding device can share the resource may be indicated by a frequency offset. The offset may indicate a starting resource block (RB) of the responding device's transmission. The indication may be expressed as a number of RBs from the starting RB of the COT. A width of the frequency may also be indicated as a number of RBs. In the examples of FIGS. 4 and 5, two frequency ranges are shown. A first frequency range is configured for UE 1 and UE 2, additionally, a second frequency range is configured for UE 3.

In some aspects of the present disclosure, the COT sharing resource may be semi-statically configured by the UE, the base station, or by hard coded rules. A UE may configure COT sharing resources when a UE sets an initial connection with the other device, and informs the COT sharing resource of the other device. The base station may configure COT sharing resources by adding new radio resource control (RRC) parameters to define how one UE may share another UE's COT. In other aspects, the base station may configure the COT sharing resource based on a sidelink connection. Where the base station knows a fixed frame period (FFP) configuration of each UE, the base station may define the sharing start offset and duration, and frequency range based on the UE's sidelink connection.

The responding device should determine whether the initiating device successfully acquired the channel. For frame-based equipment (FBE), according to aspects of the present disclosure, the responding device may detect transmission from the initiating device before the starting point of the COT. If the responding device detects transmission of the initiating device from the starting point of the COT, the responding device determines that the initiating device successfully acquired the channel. Alternatively, the responding device determines the initiating device successfully acquired the channel when the initiating device transmits a COT success indication to the responding device. The responding device learns the starting point and duration of the COT when the initiating device informs its fixed frame period structure during an initial connection with the responding device. Alternatively, the responding device learns the starting point and duration when the base station informs the responding device of the fixed frame period (FFP) structure of the initiating device. In some aspects, the base station only informs the responding device one time. For load base equipment (LBE) mode, the responding device learns whether the initiating device successfully acquired the channel by receiving a COT success indication. In addition to the COT success indication, the initiating UE indicates the starting point and duration of the COT.

A COT sharing cancellation indication may be transmitted to cancel sharing of the COT. The COT sharing cancellation indication informs the responding device that the sharing should be cancelled, in other words, that the responding device cannot share the COT. The indication may be one bit, in some aspects. Alternatively, the COT sharing may be cancelled when the initiating device does not transmit the success indication.

With pre-configured COT sharing resources, either the UE or base station pre-configures the dedicated sharing resource. However, the initiating device or responding device may end the communication earlier than the sharing starting point. In other words, resources may not be needed, or the resources may be needed for less time than configured. This may be prevented by dynamically indicating COT sharing resources. One technique for dynamic indication includes pre-configuring multiple locations and dynamically indicating the chosen location. With this technique, the initiating UE or base station pre-configures a set of fixed resources for each responding device. Frequency division resource allocation or time division resource allocation may be expressed as the percentage of COT duration or absolute value, similar to as described above with respect to FIGS. 4 and 5. The COT sharing information may also dynamically indicate which UE can share which dedicated resource.

Another technique for dynamic indication of COT sharing resources includes dynamically indicating dedicated resources for each UE. If the COT is shared with a single user, the frequency division resource allocation and time division resource allocation of the shared resource may be configured with an offset, duration, and frequency range, as described with respect to the pre-configured resources. This absolute or percentage-based configuration may occur if the responding device knows the fixed frame period (FFP) configuration of the initiating device. Alternatively, the absolute starting time, duration, starting frequency, and range of resources may be indicated.

If the COT is shared with multiple users, a UE identifier (ID) may be included. In this case, the initiating device may indicate a starting sharing time, which may either be an absolute starting time, or a percentage based on the COT duration. In this case, the shared resources should end before the next starting sharing time. In other aspects, the initiating device may also only indicate a starting point of frequency. All the information may be aggregated into one COT sharing indication (COT-SI) message.

Another technique for dynamic indication includes indicating available resources by broadcasting to all connected UEs. In this case, the UE should monitor the COT and continue contending for the channel until the channel is successfully acquired or the end point of the COT occurs.

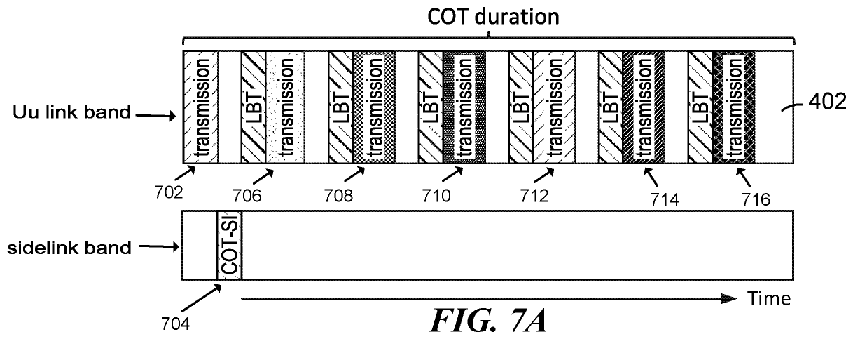

FIG. 6A is a block diagram illustrating dynamic dedicated resource allocation for COT sharing for transmissions, in accordance with aspects of the present disclosure. In FIG. 6A, an initiating device successfully acquires a COT 402, and shares the COT resources with five responding devices. In the example of FIG. 6A, the initiating UE has pre-configured resource locations. After the initiating device transmits its own traffic message, for example, a transmission 602, the initiating device transmits a COT-SI message 604. The COT-SI message 604 dynamically indicates which of the pre-configured resources each UE can share. After receiving the COT-SI message, the first, second, and third responding UEs may transmit their own traffic messages 606, 608, 610 (e.g., a PUSCH). The initiating UE may then transmit another of its traffic messages 612, before the fourth and fifth UEs transmit their traffic messages 614, 616.

FIG. 6B is a block diagram illustrating dynamic dedicated resource allocation for COT sharing for transmission bursts, in accordance with aspects of the present disclosure. Burst transmission operates similar to the single transmissions described with respect to FIG. 6A. In FIG. 6B, an initiating device successfully acquires a COT 402, and shares the COT resources with two responding devices. In this example, resource locations have been pre-configured. After the initiating device transmits its own traffic burst 620 (e.g., two transmissions and a sounding reference signal (SRS)), the initiating device transmits a COT-SI message 622. The COT-SI message 622 dynamically indicates which of the pre-configured resources each UE can share. In other words, the initiating UE dynamically indicates dedicated resources for the users. After receiving the COT-SI message 622, the first responding UE may transmit its own traffic burst 624 (e.g., two transmissions and an SRS). The second responding UE may then transmit its own traffic burst 626 (e.g., two transmissions and an SRS).

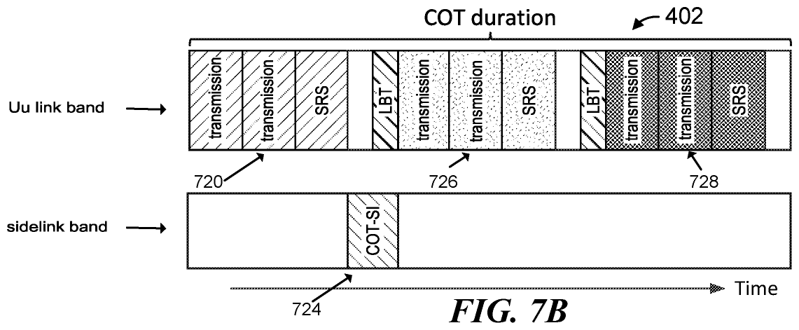

FIG. 7A is a block diagram illustrating dynamic indication of available COT sharing resources for transmissions, in accordance with aspects of the present disclosure. After the initiating device transmits its own traffic message 702, for example, a PUSCH, on a radio interface between a base station and UE (e.g., Uu band), the initiating device transmits a COT-SI message 704 on a sidelink band. The COT-SI message 704 may dynamically indicate available resources by including a UE ID for each responding UE, the start time for sharing for each responding UE, and a frequency starting point for each responding UE. The start of the sharing time may be expressed in absolute terms or may be percentage-based. After receiving the COT-SI message 704, the first, second, and third responding UEs may transmit their own traffic messages 706, 708, 710 (e.g., PUSCH), after a successful listen-before-talk (LBT) procedure. The initiating UE may then transmit another of its traffic messages 712 after its LBT procedure, before the fourth and fifth UEs transmit their traffic messages 714, 716 following their LBT procedures.

FIG. 7B is a block diagram illustrating dynamic indication of available COT sharing resources for transmission bursts, in accordance with aspects of the present disclosure. Burst transmission operates similar to the single transmissions described with respect to FIG. 7A. In FIG. 7B, an initiating device successfully acquires a COT 402, and shares the COT resources with two responding devices. After the initiating device transmits its own traffic burst 720 (e.g., two transmissions and an SRS), the initiating device transmits a COT-SI message 724. The COT-SI message 724 may include a UE ID for each responding UE, the start time for sharing for each responding UE, and a frequency starting point for each responding UE. The start of the sharing time may be expressed in absolute terms or may be percentage-based. After receiving the COT-SI message 724, the first responding UE may transmit its own traffic burst 726 (e.g., two transmissions and an SRS), after its LBT procedure. The second responding UE may then transmit its own traffic burst 728 (e.g., two transmissions and an SRS), after its LBT procedure.

Dynamic indication of COT sharing information may also be applicable in a UE cooperation scenario. UE cooperation describes the case where multiple UEs communicate via sidelink communication links to transfer information received from a base station between one another. For example, a network node may transmit a message to a first UE (e.g., target UE), although the message is intended for a second UE (e.g., cooperating UE). The first UE may recognize that the received message is intended for the second UE and may transmit or relay the message to the second UE. In some aspects, the network may be unaware of or may not directly configure or control the process of how the UEs communicate with each other to relay the information to the cooperating UE.

According to aspects of the present disclosure, for UE cooperation, only the target UE indicates the shared information, which dynamically schedules COT sharing. The target UE collects available COT information from all connected cooperative UEs, and then the target UE shares the COT to any cooperative UE that fails to contend for the channel. The cooperative UE should indicate whether it successfully contends for the channel. If the cooperative UE was not successful, the target UE does not receive the uplink grant for the cooperative UE. The cooperative UE then indicates the uplink starting transmission time and duration.

In other aspects of UE cooperation, both the target UE and cooperative UE may schedule COT sharing. The cooperative UEs may communicate amongst themselves, and thus do not need assistance from the target UE. In some aspects, the cooperative UE learns which UE fails to contend for the channel and how long each UE would need on the channel from information provided by the target UE. This information may include which UE fails the listen-before-talk (LBT) procedure, and when and how long is the uplink transmission that the UE would like to make. In other aspects, the cooperative UEs transmit sidelink information to the other cooperative UEs to learn which UEs fail to contend for the channel and how long each UE would need on the channel.

For normal sidelink scenarios, both the base station and the initiating UE may schedule COT sharing information. If the base station schedules COT sharing information, for frame-based equipment (FBE), the initiating UE informs the base station of the successful COT acquisition. For load base equipment (LBE), the initiating UE informs the base station of the starting point and duration of the COT. If the UE schedules COT sharing information, then the initiating UE only shares the COT to UEs with which the initiating UE is communicating.

As indicated above, FIGS. 3-7B are provided as examples. Other examples may differ from what is described with respect to FIGS. 3-7B.

FIG. 8 is a flow diagram illustrating an example process 800 performed, for example, by an initiating device, in accordance with various aspects of the present disclosure. The example process 800 is an example of channel occupancy time (COT) sharing. The operations of the process 800 may be implemented by a UE 120.

At block 802, the user equipment (UE) acquires a channel occupancy time (COT) including multiple subsets of COT sharing resources. Each subset of COT sharing resources includes fewer resources than the COT. For example, the UE (e.g., using the antenna 252, DEMOD/MOD 254, MIMO Detector 256, receive processor 258, controller/processor 280, and/or memory 282) may acquire the COT.

At block 804, the user equipment (UE) configures a first responding device with a first subset of COT sharing resources of the multiple subsets of COT sharing resources. For example, the UE (e.g., using antenna 234, DEMOD/MOD 254, TX MIMO processor 266, transmit processor 264, controller/processor 280, and/or memory 282) may configure the first responding device. In some aspects, configuring the first subset of COT sharing resources includes indicating an absolute location of the first subset of COT sharing resources. In some aspects, configuring of the first subset of COT sharing resources includes indicating a starting time of the first subset of COT sharing resources and a duration of the first subset of COT sharing resources. The starting time may include an offset of a first number of slots from a starting point of the COT, and the duration lasts a second number of slots. The starting time may include an offset of a first percentage of a length of the COT, and the duration may last a second percentage of the length of the COT. In some aspects, configuring the first subset of COT sharing resources includes indicating a frequency range of the first subset of COT sharing resources, the frequency range including a starting resource block and a frequency bandwidth. The configuring may occur dynamically.

At block 806, the user equipment (UE) configures a second responding device with a second subset of COT sharing resources of the multiple subsets of COT sharing resources. For example, the UE (e.g., using the antenna 234, DEMOD/MOD 254, TX MIMO processor 266, transmit processor 264, controller/processor 280, and/or memory 282) may configure the second responding device. The first subset of COT sharing resources may be orthogonal to the second subset of COT sharing resources in a frequency domain and/or a time domain

FIG. 9 is a flow diagram illustrating an example process 900 performed, for example, by a responding device, in accordance with various aspects of the present disclosure. The example process 900 is an example of channel occupancy time (COT) sharing. The operations of the process 900 may be implemented by a base station 130.

At block 902, the base station receives, from an initiating device, a first subset of channel occupancy time (COT) sharing resources of multiple subsets of COT sharing resources of a COT, the first subset of COT sharing resources differing from a second subset of COT sharing resources configured for another device. For example, the UE (e.g., using the antenna 234, MOD/DEMOD 232, MIMO Detector 236, receive processor 238, controller/processor 240, and/or memory 242) may receive the COT. The first subset of COT sharing resources may comprises multiple resource locations.

At block 904, the base station selects transmission resources from the first subset of COT sharing resources in response to detecting the initiating device acquired the COT. For example, the UE (e.g., using controller/processor 240, and/or memory 242) may select the transmission resources. In some aspects, detecting that the initiating device acquired the COT comprises detecting a transmission from the initiating device before a starting point of the COT. In other aspects, detecting that the initiating device acquired the COT comprises receiving a success indication from the initiating device, and a starting point of the first subset of COT sharing resources and a duration of the first subset of COT sharing resources. In still other aspects, detecting that the initiating device acquired the COT comprises receiving a COT success indication from the initiating device, and a fixed frame period of the initiating device.

At block 906, the base station transmits data on the selected transmission resources. For example, the UE (e.g., using the antenna 234, MOD/DEMOD 232, TX MIMO processor 230, transmit processor 220, controller/processor 240, and/or memory 242) may transmit the data.

### Example Aspects

Aspect 1: A method of wireless communication by an initiating device, comprising: acquiring a channel occupancy time (COT) including a plurality of subsets of COT sharing resources, each of the plurality of subsets of COT sharing resources including fewer resources than the COT; configuring a first responding device with a first subset of COT sharing resources of the plurality of subsets of COT sharing resources; and configuring a second responding device with a second subset of COT sharing resources of the plurality of subsets of COT sharing resources.

Aspect 2: The method of Aspect 1, in which the first subset of COT sharing resources is orthogonal to the second subset of COT sharing resources in a frequency domain and/or a time domain.

Aspect 3: The method of Aspect 1 or 2, in which the configuring of the first subset of COT sharing resources includes indicating an absolute location of the first subset of COT sharing resources.

Aspect 4: The method of any of the preceding Aspects, in which the first subset of COT sharing resources comprises a plurality of resource locations, the method further comprising transmitting a triggering signal indicating a specific location of the plurality of resource locations for use by the first responding device.

Aspect 5: The method of any of the preceding Aspects, in which the configuring of the first subset of COT sharing resources includes indicating a starting time of the first subset of COT sharing resources and a duration of the first subset of COT sharing resources, the starting time including an offset of a first number of slots from a starting point of the COT, and the duration lasting a second number of slots.

Aspect 6: The method of any of Aspects 1-4, in which the configuring of the first subset of COT sharing resources includes indicating a starting time of the first subset of COT sharing resources and a duration of the first subset of COT sharing resources, the starting time including an offset of a first percentage of a length of the COT, the duration lasting a second percentage of the length of the COT.

Aspect 7: The method of any of the preceding Aspects, in which the configuring of the first subset of COT sharing resources includes indicating a frequency range of the first subset of COT sharing resources, the frequency range including a starting resource block and a frequency bandwidth.

Aspect 8: The method of any of the preceding Aspects, further comprising receiving, from a base station, signaling indicating COT sharing parameters.

Aspect 9: The method of any of the preceding Aspects, in which the configuring of the first subset of COT sharing resources occurs dynamically.

Aspect 10: The method of any of the preceding Aspects, further comprising collecting available COT sharing information from a plurality of cooperative user equipment (UEs) before configuring the first responding device and configuring the second responding device.

Aspect 11: A method of wireless communication by a responding device, comprising: receiving, from an initiating device, a first subset of channel occupancy time (COT) sharing resources of a plurality of subsets of COT sharing resources of a COT, the first subset of COT sharing resources differing from a second subset of COT sharing resources configured for another device; selecting transmission resources from the first subset of COT sharing resources in response to detecting the initiating device acquired the COT; and transmitting data on the selected transmission resources.

Aspect 12: The method of Aspect 11, in which detecting that the initiating device acquired the COT comprises detecting a transmission from the initiating device before a starting point of the COT.

Aspect 13: The method of Aspect 11 or 12, in which detecting that the initiating device acquired the COT comprises receiving a success indication from the initiating device, and a starting point of the first subset of COT sharing resources and a duration of the first subset of COT sharing resources.

Aspect 14: The method of any of the Aspects 11-13, in which detecting that the initiating device acquired the COT comprises receiving a COT success indication from the initiating device, and a fixed frame period of the initiating device.

Aspect 15: The method of any of the Aspects 11-14, further comprising receiving a COT sharing cancellation from the initiating device.

Aspect 16: The method of any of the Aspects 11-15, in which the first subset of COT sharing resources comprises a plurality of resource locations, the method further comprising receiving a triggering signal indicating a specific location of the plurality of resource locations for use by the responding device.

Aspect 17: The method of any of the Aspects 11-16, further comprising receiving a starting time of the first subset of COT sharing resources and a duration of the first subset of COT sharing resources, the starting time expressed as an offset of a first number of slots from a starting point of the COT, the duration lasting a second number of slots.

Aspect 18: The method of any of the Aspects 11-16, further comprising receiving a starting time of the first subset of COT sharing resources and a duration of the first subset of COT sharing resources, the starting time indicated as a percentage of a length of the COT, the duration lasting the percentage of the length of the COT.

Aspect 19: The method of any of the Aspects 11-18, further comprising receiving a frequency range of the first subset of COT sharing resources, the frequency range including a starting resource block and a frequency bandwidth.

Aspect 20: The method of any of the Aspects 11-19, in which the first subset of COT sharing resources is received dynamically.

Aspect 21: An apparatus for wireless communication by an initiating device, comprising: a memory; and at least one processor coupled to the memory, the at least one processor configured: to acquire a channel occupancy time (COT) including a plurality of subsets of COT sharing resources, each of the plurality of subsets of COT sharing resources including fewer resources than the COT; to configure a first responding device with a first subset of COT sharing resources of the plurality of subsets of COT sharing resources; and to configure a second responding device with a second subset of COT sharing resources of the plurality of subsets of COT sharing resources.

Aspect 22: The apparatus of Aspect 21, in which the first subset of COT sharing resources is orthogonal to the second subset of COT sharing resources in a frequency domain and/or a time domain.

Aspect 23: The apparatus of Aspect 21 or 22, in which the at least one processor is configured to configure the first subset of COT sharing resources by indicating an absolute location of the first subset of COT sharing resources.

Aspect 24: The apparatus of any of the Aspects 21-23, in which the first subset of COT sharing resources comprises a plurality of resource locations, the at least one processor further configured to transmit a triggering signal indicating a specific location of the plurality of resource locations for use by the first responding device.

Aspect 25: The apparatus of any of the Aspects 21-24, in which the at least one processor is configured to configure the first subset of COT sharing resources by indicating a starting time of the first subset of COT sharing resources and a duration of the first subset of COT sharing resources, the starting time including an offset of a first number of slots from a starting point of the COT, and the duration lasting a second number of slots.

Aspect 26: The apparatus of any of the Aspects 21-24, in which the at least one processor is configured to configure the first subset of COT sharing resources by indicating a starting time of the first subset of COT sharing resources and a duration of the first subset of COT sharing resources, the starting time including an offset of a first percentage of a length of the COT, the duration lasting a second percentage of the length of the COT.

Aspect 27: The apparatus of any of the Aspects 21-26, in which the at least one processor is configured to configure the first subset of COT sharing resources by indicating a frequency range of the first subset of COT sharing resources, the frequency range including a starting resource block and a frequency bandwidth.

Aspect 28: The apparatus of any of the Aspects 21-27, in which the at least one processor is further configured to receive, from a base station, signaling indicating COT sharing parameters.

Aspect 29: The apparatus of any of the Aspects 21-28, in which the at least one processor is configured to dynamically configure the first subset of COT sharing resources.

Aspect 30: The apparatus of any of the Aspects 21-29, in which the at least one processor is further configured to collect available COT sharing information from a plurality of cooperative user equipment (UEs) before configuring the first responding device and configuring the second responding device.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code—it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

What is claimed is:

1. A method of wireless communication by an initiating device, comprising:
acquiring a channel occupancy time (COT) including a plurality of subsets of COT sharing resources, each of the plurality of subsets of COT sharing resources including fewer resources than the COT;
configuring a first responding device with a first subset of COT sharing resources of the plurality of subsets of COT sharing resources; and
configuring a second responding device with a second subset of COT sharing resources of the plurality of subsets of COT sharing resources.

2. The method of claim 1, in which the first subset of COT sharing resources is orthogonal to the second subset of COT sharing resources in a frequency domain and/or a time domain.

3. The method of claim 1, in which the configuring of the first subset of COT sharing resources includes indicating an absolute location of the first subset of COT sharing resources.

4. The method of claim 1, in which the first subset of COT sharing resources comprises a plurality of resource locations, the method further comprising transmitting a triggering signal indicating a specific location of the plurality of resource locations for use by the first responding device.

5. The method of claim 1, in which the configuring of the first subset of COT sharing resources includes indicating a starting time of the first subset of COT sharing resources and a duration of the first subset of COT sharing resources, the starting time including an offset of a first number of slots from a starting point of the COT, and the duration lasting a second number of slots.

6. The method of claim 1, in which the configuring of the first subset of COT sharing resources includes indicating a starting time of the first subset of COT sharing resources and a duration of the first subset of COT sharing resources, the starting time including an offset of a first percentage of a length of the COT, the duration lasting a second percentage of the length of the COT.

7. The method of claim 1, in which the configuring of the first subset of COT sharing resources includes indicating a frequency range of the first subset of COT sharing resources, the frequency range including a starting resource block and a frequency bandwidth.

8. The method of claim 1, further comprising receiving, from a base station, signaling indicating COT sharing parameters.

9. The method of claim 1, in which the configuring of the first subset of COT sharing resources occurs dynamically.

10. The method of claim 1, further comprising collecting available COT sharing information from a plurality of cooperative user equipment (UEs) before configuring the first responding device and configuring the second responding device.

11. A method of wireless communication by a responding device, comprising:
receiving, from an initiating device, a first subset of channel occupancy time (COT) sharing resources of a plurality of subsets of COT sharing resources of a COT, the first subset of COT sharing resources differing from a second subset of COT sharing resources configured for another device;
selecting transmission resources from the first subset of COT sharing resources in response to detecting the initiating device acquired the COT; and
transmitting data on the selected transmission resources.

12. The method of claim 11, in which detecting that the initiating device acquired the COT comprises detecting a transmission from the initiating device before a starting point of the COT.

13. The method of claim 11, in which detecting that the initiating device acquired the COT comprises receiving a success indication from the initiating device, and a starting point of the first subset of COT sharing resources and a duration of the first subset of COT sharing resources.

14. The method of claim 11, in which detecting that the initiating device acquired the COT comprises receiving a COT success indication from the initiating device, and a fixed frame period of the initiating device.

15. The method of claim 11, further comprising receiving a COT sharing cancellation from the initiating device.

16. The method of claim 11, in which the first subset of COT sharing resources comprises a plurality of resource locations, the method further comprising receiving a triggering signal indicating a specific location of the plurality of resource locations for use by the responding device.

17. The method of claim 11, further comprising receiving a starting time of the first subset of COT sharing resources and a duration of the first subset of COT sharing resources, the starting time expressed as an offset of a first number of slots from a starting point of the COT, the duration lasting a second number of slots.

18. The method of claim 11, further comprising receiving a starting time of the first subset of COT sharing resources and a duration of the first subset of COT sharing resources, the starting time indicated as a percentage of a length of the COT, the duration lasting the percentage of the length of the COT.

19. The method of claim 11, further comprising receiving a frequency range of the first subset of COT sharing resources, the frequency range including a starting resource block and a frequency bandwidth.

20. The method of claim 11, in which the first subset of COT sharing resources is received dynamically.

21. An apparatus for wireless communication by an initiating device, comprising:
a memory; and
at least one processor coupled to the memory, the at least one processor configured:
to acquire a channel occupancy time (COT) including a plurality of subsets of COT sharing resources, each of the plurality of subsets of COT sharing resources including fewer resources than the COT;
to configure a first responding device with a first subset of COT sharing resources of the plurality of subsets of COT sharing resources; and
to configure a second responding device with a second subset of COT sharing resources of the plurality of subsets of COT sharing resources.

22. The apparatus of claim 21, in which the first subset of COT sharing resources is orthogonal to the second subset of COT sharing resources in a frequency domain and/or a time domain.

23. The apparatus of claim 21, in which the at least one processor is configured to configure the first subset of COT sharing resources by indicating an absolute location of the first subset of COT sharing resources.

24. The apparatus of claim 21, in which the first subset of COT sharing resources comprises a plurality of resource locations, the at least one processor further configured to transmit a triggering signal indicating a specific location of the plurality of resource locations for use by the first responding device.

25. The apparatus of claim 21, in which the at least one processor is configured to configure the first subset of COT sharing resources by indicating a starting time of the first subset of COT sharing resources and a duration of the first subset of COT sharing resources, the starting time including an offset of a first number of slots from a starting point of the COT, and the duration lasting a second number of slots.

26. The apparatus of claim 21, in which the at least one processor is configured to configure the first subset of COT sharing resources by indicating a starting time of the first subset of COT sharing resources and a duration of the first subset of COT sharing resources, the starting time including an offset of a first percentage of a length of the COT, the duration lasting a second percentage of the length of the COT.

27. The apparatus of claim 21, in which the at least one processor is configured to configure the first subset of COT sharing resources by indicating a frequency range of the first subset of COT sharing resources, the frequency range including a starting resource block and a frequency bandwidth.

28. The apparatus of claim 21, in which the at least one processor is further configured to receive, from a base station, signaling indicating COT sharing parameters.

29. The apparatus of claim 21, in which the at least one processor is configured to dynamically configure the first subset of COT sharing resources.

30. The apparatus of claim 21, in which the at least one processor is further configured to collect available COT sharing information from a plurality of cooperative user equipment (UEs) before configuring the first responding device and configuring the second responding device.
